(19) United States
(12) Patent Application Publication
(10) Pub. No.: US 2025/0322682 A1
(43) Pub. Date: Oct. 16, 2025

(54) IMAGE PROCESSING DEVICE, IMAGE PROCESSING SYSTEM, IMAGE PROCESSING METHOD, AND STORAGE MEDIUM

(71) Applicant: CANON KABUSHIKI KAISHA, Tokyo (JP)

(72) Inventor: Tomoya HONJO, Tokyo (JP)

(21) Appl. No.: 19/094,281

(22) Filed: Mar. 28, 2025

(30) Foreign Application Priority Data
Apr. 10, 2024 (JP) 2024-063154
Oct. 25, 2024 (JP) 2024-188566

(51) Int. Cl. G06V 20/70; G06T 3/4038; G06T 5/70; G06T 7/70; G06V 10/25

(52) U.S. Cl. CPC G06V 20/70; G06T 3/4038; G06T 5/70; G06T 7/70; G06V 10/25; G06T 2207/20081

(57) ABSTRACT

An image processing device sets one or more regions in a first image as a protection region, generates image description information as information expressing at least a portion of the first image, generates a second image based on lossy processing for the protection region in the first image, and performs control such that a training image used for training a learning model for image analysis processing is generated based on the second image and the image description information.

### BACKGROUND

### Technical Field

The present disclosure relates to an image processing device, an image processing system, an image processing method, a storage medium, and the like.

### Description of the Related Art

In recent years, image analysis has been carried out in a variety of situations, using images captured by imaging devices such as surveillance cameras and machine learning techniques to detect, track, and estimate attributes of objects. To improve the accuracy of image analysis, additional training may be performed using data from scenes in which the image is actually used.

At this time, the image may contain regions that need to be protected, such as a person's face or confidential information. When such regions are simply subjected to lossy processing (also known as lossy conversion) such as blurring, the feature values of the image will change significantly when the deviation from the image before the lossy processing becomes large, making the image unsuitable for use as training data.

To address such issues, Japanese Patent Laid-Open No. 2016-126597 discloses a technology that outputs feature values in a protection region and an image obtained by irreversibly converting the protection region, and uses the feature values in the protection region during training.

In Japanese Patent Laid-Open No. 2016-126597, there is a problem in that the feature values of the protection region are used for training.

### SUMMARY

In order to achieve the above object, according to one aspect of the present disclosure, there is provided an image processing device including: at least one processor; and a memory coupled to the at least one processor, the memory storing instructions that, when executed by the at least one processor, cause the at least one processor to: set one or more regions in a first image as a protection region; generate image description information as information expressing at least a portion of the first image; generate a second image based on lossy processing for the protection region in the first image; and perform control such that a training image used for training a learning model for image analysis processing is generated based on the second image and the image description information.

Further features of the present disclosure will become apparent from the following description of embodiments with reference to the attached drawings.

### BRIEF DESCRIPTION OF THE DRAWINGS

FIG. 1 is a diagram illustrating an example of a configuration of an image processing device and a learning device according to a first embodiment.

FIG. 2 is a diagram illustrating an example of a functional configuration of the image processing device and the learning device according to the first embodiment.

FIG. 3 is a flowchart illustrating additional training processing according to the first embodiment.

FIG. 4 is a flowchart illustrating additional training processing according to the first embodiment.

FIGS. 5A to 5D are diagrams illustrating additional training processing according to the first embodiment.

FIGS. 6A to 6C are diagrams illustrating additional training processing according to the first embodiment.

FIG. 7 is a diagram illustrating an example of a screen for correcting image description information according to the first embodiment.

FIG. 8 is a diagram illustrating an example of a functional configuration of an image processing device and a learning device according to a second embodiment.

FIG. 9 is a flowchart illustrating additional training processing according to the second embodiment.

FIG. 10 is a flowchart illustrating additional training processing according to the second embodiment.

FIGS. 11A to 11C are diagrams illustrating additional training processing according to the second embodiment.

FIGS. 12A and 12B are diagrams illustrating additional training processing according to the second embodiment.

FIGS. 13A to 13E are diagrams illustrating additional training processing according to the third embodiment.

FIGS. 14A to 14C are diagrams illustrating additional training processing according to the third embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

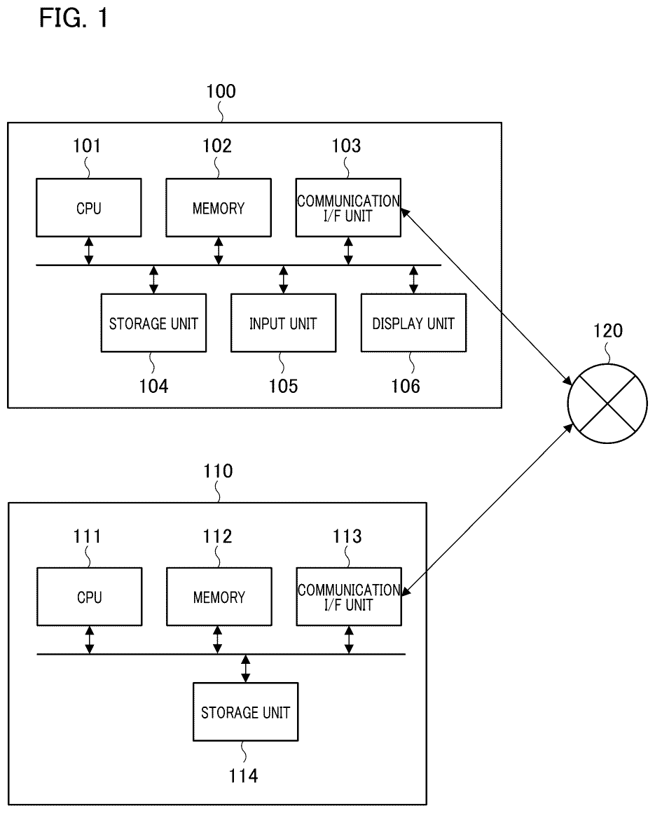

FIG. 1 is a block diagram illustrating an example of the configuration of an image processing system including an image processing device 100 and a learning device 110 according to the present embodiment. The image processing device 100 and the learning device 110 are communicatively connected via a network 120.

The image processing device 100 in the present embodiment has a data generation function of generating data necessary for additional training by selecting an image that a user wishes to additionally train for an object detection device using machine learning (not illustrated), and a transmission function of transmitting data to the learning device 110.

The learning device 110 has an image generation function of generating images from data required for additional training, a learning function of performing additional training using the generated images, and a transmission function of transmitting the training results to the image processing device 100. The following will describe the case of additionally training a machine learning model for detecting vehicles as an example, but the present disclosure is not limited thereto and can be applied to a system that trains any machine learning model.

The image processing device 100 in the present embodiment includes a CPU 101, a memory 102, a communication interface (I/F) unit 103, a storage unit 104, an input unit 105, and a display unit 106. The CPU 101, the memory 102, the communication I/F unit 103, the storage unit 104, input unit 105, and the display unit 106 are communicatively connected via a system bus. The image processing device 100 according to the present embodiment may further include other configurations.

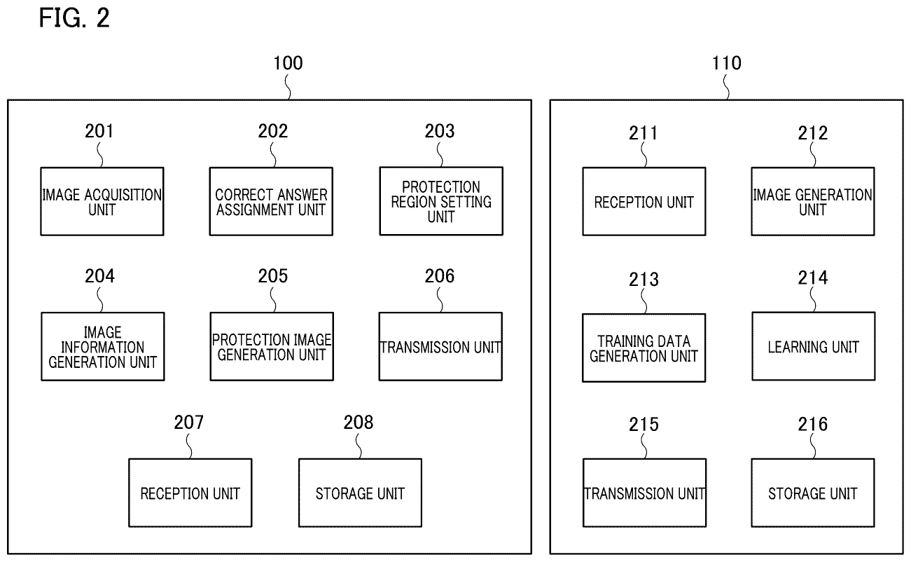

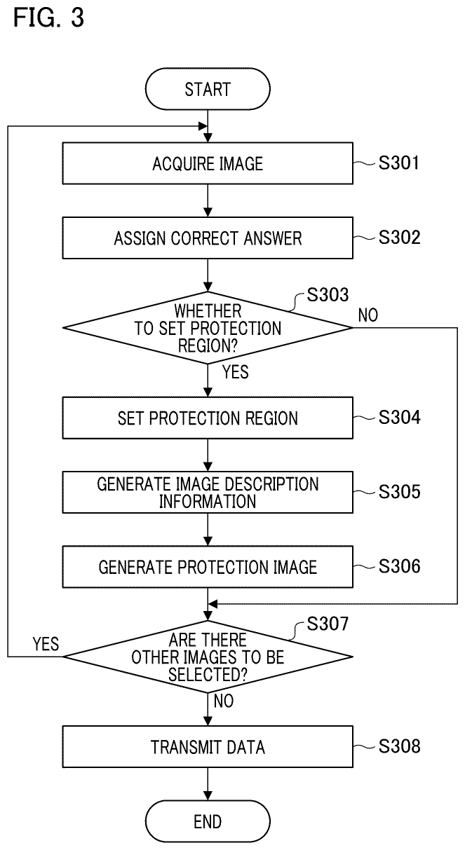

The CPU (central processing unit) 101 is a central processing unit that controls the entire image processing device 100. The CPU 101 controls the operation of each functional unit of the image processing device 100 connected via, for example, a system bus. The memory 102 stores data, programs, etc. that the CPU 101 uses for processing. The memory 102 functions as a main memory, a work area, etc. for the CPU 101. The CPU 101 executes processing based on a program stored in the memory 102, thereby realizing the functional configuration of the image processing device 100 illustrated in FIG. 2 and the processing of a flowchart illustrated in FIG. 3, which will be described later.

The communication I/F unit 103 is an interface that connects the image processing device 100 to a network. The storage unit 104 stores, for example, various types of data required when the CPU 101 performs processing related to the programs. The storage unit 104 also stores various types of data and the like obtained by the CPU 101 performing processing related to the programs, for example. The data, programs, etc. used by the CPU 101 for processing may be stored in the storage unit 104. The input unit 105 has operation members such as a mouse or buttons, and inputs user operations to the image processing device 100. The display unit 106 has a display member such as a liquid crystal display, and displays the results of processing by the CPU 101, etc.

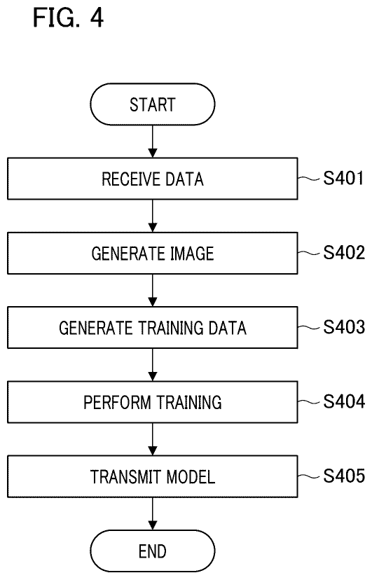

The learning device 110 includes a CPU 111, a memory 112, a communication I/F unit 113, and a storage unit 114. The CPU 111, the memory 112, the communication I/F unit 113, and the storage unit 114 are communicatively connected via a system bus. The CPU 111, the memory 112, the communication I/F unit 113, and the storage unit 114 of the learning device 110 have the same functions as the CPU 101, the memory 102, the communication I/F unit 103, and the storage unit 104 of the image processing device 100. Therefore, a description of the CPU 111, the memory 112, the communication I/F unit 113, and the storage unit 114 of the learning device 110 will be omitted. Further, the CPU 111 executes processing based on a program stored in the memory 112, thereby realizing the functional configuration of the learning device 110 illustrated in FIG. 2 and the processing of a flowchart illustrated in FIG. 4, which will be described later.

FIG. 2 is a block diagram illustrating an example of the functional configuration of the image processing device 100 and the learning device 110. The image processing device 100 includes an image acquisition unit 201, a correct answer assignment unit 202, a protection region setting unit 203, an image information generation unit 204, a protection image generation unit 205, a transmission unit 206, a reception unit 207, and a storage unit 208.

The image acquisition unit 201 acquires one or more designated images. In the present embodiment, one or more images designated by the user through the input unit 105 are acquired. At this time, the image acquisition unit 201 acquires the image designated by the user from among the images stored in the storage unit 104.

The correct answer assignment unit 202 assigns correct answer data to the image. In the present embodiment, for an image acquired by the image acquisition unit 201, the user designates (determines), as correct answer data, the position (x, y) in the image of a frame (rectangular frame) surrounding a vehicle (object) to be detected and its size (w, h) in the image, via the input unit 105.

The protection region setting unit 203 sets a region of an image that is desired to be protected as a protection region. In the present embodiment, for an image acquired by the image acquisition unit 201, the user uses the input unit 105 to designate one or more rectangular regions in the image that he or she wishes to protect. The protection region setting unit 203 then sets the rectangular region designated by the user operation as a protection region. Furthermore, the protection region setting unit 203 detects (or calculates) and sets the position (x, y) of the rectangle in the image of the protection region and its size (w, h) in the image.

The image information generation unit 204 analyzes the designated region in the image set by the correct answer assignment unit 202, and generates semantic information (image description information) that is information expressing the designated region (at least a portion of the image). In the present embodiment, information expressing a designated region is, for example, information such as “a face of a person wearing a hat” or “a station wagon with a Japanese license plate with Japanese writing on the hood, parked in a parking lot.” That is, information expressing a subject such as a person, a living thing, an object, etc., that appears in the designated region of the image, or a scene in the image, is regarded as information expressing the designated region. In addition, in the present embodiment, the entire image is set as a designated region, and text that describes the image (describes the designated region of the image) is generated and output as image description information (text information). The function of analyzing such an image and generating predetermined information can be realized by applying known technology, and therefore a description thereof will be omitted.

The protection image generation unit 205 performs lossy processing on the image to create a protection region. In the present embodiment, a new image is generated in which a protection region, which is a region designated by a user, in an image acquired by the image acquisition unit 201 is protected by filling the protection region with, for example, gray. In other words, the protection image generation unit 205 functions as an image processing unit. Incidentally, the lossy processing is not limited to filling, and various techniques such as lossy mosaic processing and blurring processing can be used. Furthermore, the color used to fill the protection region is not limited to gray, but any color can be designated.

The transmission unit 206 transmits data required for additional training to an external device or the like. The image processing device 100 of the present embodiment transmits, to the learning device 110, an image, correct answer data corresponding to the image, and image description information that is information expressing a designated region. The reception unit 207 receives a trained machine learning model from an external device, etc. The image processing device 100 of the present embodiment receives a trained machine learning model from the learning device 110. The storage unit 208 stores data used for processing in the image acquisition unit 201, the correct answer assignment unit 202, the protection region setting unit 203, the image information generation unit 204, the protection image generation unit 205, the transmission unit 206, and the reception unit 207 of the image processing device 100, as well as data obtained as a result of processing. The machine learning model received from the learning device 110 and stored in the storage unit 208 is used as appropriate for various types of image analysis processing such as object detection, tracking, and attribute estimation. In other words, the CPU 101 of the image processing device 100 can execute image analysis processing using the machine learning model received from the learning device 110.

The learning device 110 includes a reception unit 211, an image generation unit 212, a training data generation unit 213, a learning unit 214, a transmission unit 215, and a storage unit 216.

The reception unit 211 receives predetermined data required for additional training from an external device or the like. In the present embodiment, an image, correct answer data corresponding to the image, and image description information that is information expressing the image are received from the image processing device 100.

The image generation unit 212 generates training images (images for training) from data required for additional training. In the present embodiment, for an image for which image description information, which is information expressing the image, exists, a training image is generated as an image for training from the image and the image description information, which is information expressing (describing) the image. The function of generating an image from image description information (prompt), which is information expressing such an image, can be realized by applying known technology, and therefore a description thereof will be omitted.

The training data generation unit 213 stores the image and the correct answer data corresponding to the image as training data. The learning unit 214 trains a machine learning model using the training data. In the present embodiment, a combination of an image for training and correct answer data corresponding thereto is used as training data, and a machine learning model for detecting a vehicle is additionally trained using the training data. Since there are known technologies for the machine learning model to be additionally trained, a description thereof will be omitted.

The transmission unit 215 transmits the trained machine learning model to the outside. In the present embodiment, a machine learning model for detecting a vehicle that has been trained is transmitted to the image processing device 100. The storage unit 216 stores data used for processing in the reception unit 211, the image generation unit 212, the training data generation unit 213, and the learning unit 214 of the learning device 110, as well as data obtained as a result of the processing.

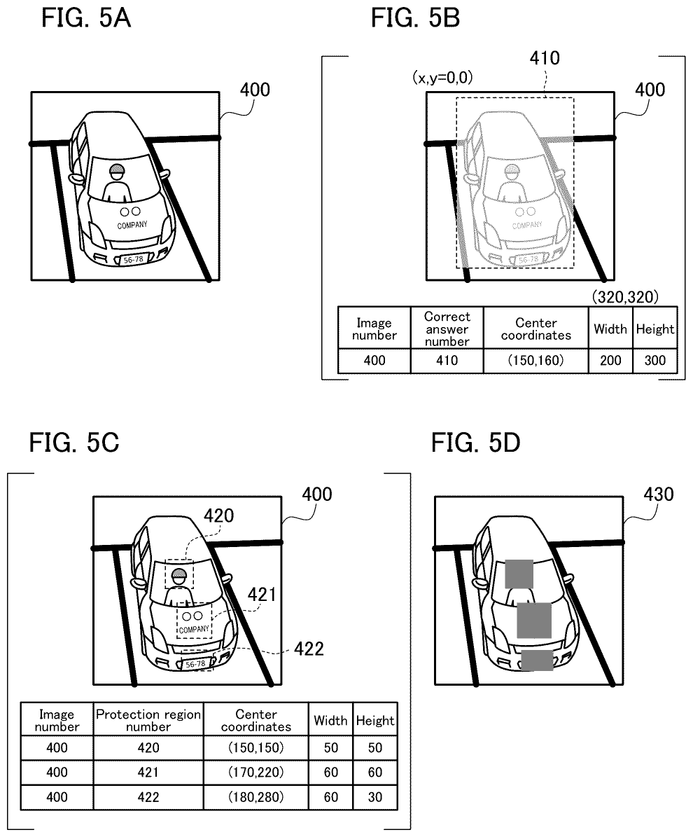

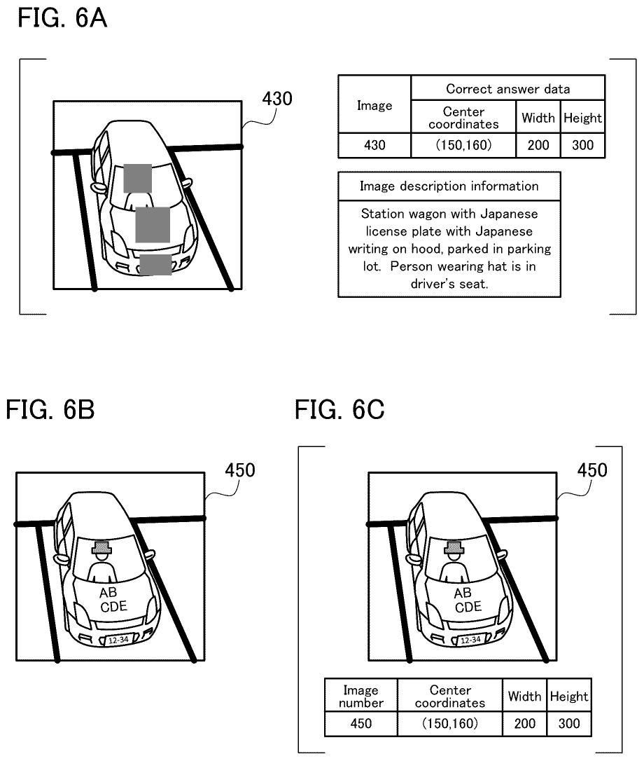

Next, the processes performed by the image processing device 100 and the learning device 110 will be described with reference to FIGS. 3 to 6C. FIGS. 3 and 4 are flowcharts illustrating additional training processing according to the first embodiment. Specifically, FIG. 3 is a flowchart of the processing on the image processing device 100 side in the additional training processing, and FIG. 4 is a flowchart of the processing on the learning device 110 side in the additional training processing. FIGS. 5A to 6C are diagrams illustrating additional training processing according to the first embodiment.

In the following, with regard to the additional training processing of the present embodiment, first, the process performed on the image processing device 100 side will be described with reference to FIG. 3. Each of the following processes illustrated in FIG. 3 is realized by the CPU 101 of the image processing device 100 executing a program stored in the memory 102. Furthermore, each process (step) is represented by adding an S to the beginning of the process (step), thereby omitting the notation of the process (step).

In S301, the image acquisition unit 201 acquires one image designated by the user (hereinafter, a designated image). That is, when the user uses the input unit 105 to designate an image to be acquired, the image acquisition unit 201 acquires the designated image (designated image) from the storage unit 104. In the present embodiment, the image acquisition unit 201 acquires an image illustrated in FIG. 5A as an example. In the drawing, reference numeral 400 is the image number of the acquired image.

In S302, the correct answer assignment unit 202 designates (determines) the position of a frame 410 surrounding a vehicle that the user wishes to detect and the size of the frame 410 in the designated image acquired in S301 as correct answer data. The correct answer data is stored in the storage unit 104 together with the image number 400. That is, when the user uses the input unit 105 to set a frame 410 surrounding a vehicle in a designated image, the correct answer assignment unit 202 designates the frame 410 surrounding the vehicle and the size of the frame 410 (width 200, height 300) as correct answer data, as illustrated in FIG. 5B. Then, the correct answer data is stored in the storage unit 104 in association with the image number 400.

In S303, the protection region setting unit 203 determines whether or not to set a protection region, which is a region that the user wishes to protect, in the designated image. If it is determined that a protection region is to be set, the process proceeds to S304. On the other hand, if it is determined that a protection region is not to be set, the process proceeds to S307. Specifically, the protection region setting unit 203 notifies (inquires) the user as to whether or not to set a protection region, and the user transmits a response corresponding to the notification to the protection region setting unit 203 by operating the input unit 105. That is, when the control command transmitted to the protection region setting unit 203 by the user operation is a command to set a protection region, the protection region setting unit 203 sets a protection region and proceeds to S304. On the other hand, when the control command transmitted to the protection region setting unit 203 by the user operation is a command not to set a protection region, the protection region setting unit 203 does not set a protection region and proceeds to S307.

In S304, when the user designates a region that is desired to be protected (hereinafter, a protection region) in the designated image as a rectangle, the protection region setting unit 203 sets the position and size of the designated rectangle. The protection region setting unit 203 then stores the designated protection region together with the image number 400. That is, when the user uses the input unit 105 to designate one or more rectangular regions in the designated image that he or she wishes to protect, the protection region setting unit 203 sets the designated regions as protection regions. Furthermore, the position (x, y) and size (w, h) of a rectangle in the designated image that is the protection region are detected, and a number is assigned to the protection region. For example, as illustrated in FIG. 5C, when three regions are designated by a user operation as rectangles, each of the designated regions is set as a protection region. Furthermore, the position (x, y) and size (w, h) of the rectangle of each protection region are detected, and each of protection regions 420, 421, and 422 is numbered. Then, the protection region setting unit 203 stores the protection regions 420, 421, and 423 in the storage unit 104 in association with the image number 400.

In S305, the image information generation unit 204 analyzes the designated region of the designated image and outputs text describing the designated image as image description information. Here, it is assumed that the text obtained is “A station wagon with a Japanese license plate with Japanese writing on the hood, parked in a parking lot. A person wearing a hat is in the driver's seat.” The image description information is stored along with the image number. As described above, in the present embodiment, the entire designated image is the designated region.

In S306, the protection image generation unit 205 performs lossy conversion on the protection region of the designated image to generate a new image. The protection image generation unit 205 of the present embodiment generates an image (hereinafter, a protection image) in which a protection region set in a designated image is filled with gray, as an example of lossy conversion. FIG. 5D illustrates an example of a protection image (second image), which is an image in which the protection region is filled in gray by the protection image generation unit 205. Furthermore, the protection image generation unit 205 updates the image number 400 of the correct answer data, the protection region, and the image description information to an image number 430.

In S307, the image acquisition unit 201 determines whether or not there are other images to be used for additional training. If it is determined that there are other images, the process proceeds to S301, and the same process as above is performed. On the other hand, if it is determined that there are no other images, the process proceeds to S308. Specifically, the image acquisition unit 201 notifies (inquires) the user as to whether or not there are other images to be used for additional training, and the user transmits a response corresponding to the notification to the image acquisition unit 201 by operating the input unit 105. That is, when the control command transmitted to the image acquisition unit 201 by the user operation is a command indicating that there are other images to be used for additional training, the process proceeds to S301. On the other hand, when the control command transmitted to the image acquisition unit 201 by the user operation is a command indicating that there are no other images to be used for additional training, the process proceeds to S308.

In S308, when a protection region has been set, the transmission unit 206 transmits a protection image, correct answer data corresponding to the protection image, and image description information to the learning device 110. On the other hand, when a protection region has not been set, the designated image and the correct answer data corresponding to the designated image are transmitted to the learning device 110. FIG. 6A illustrates an example of a protection image, correct answer data corresponding to the protection image, and image description information that are transmitted to the learning device 110 when a protection region has been set. The above is the process on the image processing device 100 side.

Next, with regard to the additional training processing of the present embodiment, the process performed on the learning device 110 side will be described with reference to FIG. 4. Each of the following processes illustrated in FIG. 4 is realized by the CPU 111 of the learning device 110 executing a program stored in the memory 112. Furthermore, each process (step) is represented by adding an S to the beginning of the process (step), thereby omitting the notation of the process (step).

In S401, when a protection region has been set, the reception unit 211 receives, from the image processing device 100, each piece of data including a protection image, correct answer data corresponding to the protection image, and image description information. On the other hand, when a protection region has not been set, each piece of data including a designated image and correct answer data corresponding to the designated image is received.

In S402, when the image description information is received in S401, the image generation unit 212 generates an image for training (hereinafter, a training image) based on the protection image and the image description information. FIG. 6B illustrates an example of the training image generated by the image generation unit 212. Thereafter, the image generation unit 212 replaces the image number 430 of the correct answer data corresponding to the protection image with an image number 450 of the training image.

In S403, the training data generation unit 213 stores the training image and the correct answer data corresponding to the training image in the storage unit 114 as training data. FIG. 6C illustrates an example in which the training image and the correct answer data corresponding to the training image are stored as training data by the training data generation unit 213.

In S404, the learning unit 214 additionally trains a machine learning model for detecting vehicles using the training data stored in S403 (by reading the training data from the storage unit 114). In S405, the transmission unit 215 transmits the machine learning model for detecting vehicles that has been trained to the image processing device 100. The above is the process on the learning device 110 side.

Note that, instead of the image generation unit 212 of the learning device 110, for example, the image information generation unit 204 or the protection image generation unit 205 of the image processing device 100 may generate the training image. Specifically, the image information generation unit 204 and the protection image generation unit 205 generate training images based on the protection image and image description information. In addition, the image number of the correct answer data corresponding to the protection image is replaced with the number of the training image. Thereafter, the transmission unit 206 may transmit the generated training image and the correct answer data corresponding to the training image to the learning device 110. Then, the training data generation unit 213 of the learning device 110 stores the training image received via the reception unit 211 and the correct answer data corresponding to the training image in the storage unit 114. Then, the processes of S404 and S405 are performed in the same manner as above.

### Modification Example

In the present embodiment, the image processing device 100 and the learning device 110 are configured to be separated via a network, but may be integrated into a single device (image processing device). That is, each configuration and functional unit of the learning device 110 can be configured within the image processing device 100. In this manner, the processes illustrated in FIGS. 3 and 4 can be performed by one CPU. In the present embodiment, the CPU 101 or the CPU 111 executes a program stored in either the memory 102 or the memory 112 to control the operation of each functional unit, thereby realizing the processes illustrated in FIGS. 3 and 4. Furthermore, when integrated into a single device, the CPU, the memory, the communication I/F unit, and the storage unit that the image processing device 100 and the learning device 110 each have may be unified. In such a case, a CPU in one device executes a program stored in a memory to control the operation of each functional unit of each device, thereby realizing the processes illustrated in FIGS. 3 and 4. In this case, for example, the image processing device 100 can perform each process such as a training image generation process of the image generation unit 212, a training data generation process of the training data generation unit 213, and a machine learning process of the learning unit 214.

In addition, the above-mentioned learning device 110 has an image generation function of generating images from data required for additional training, a learning function of performing additional training using the generated images, and a transmission function of transmitting the training results to the image processing device 100, but the present disclosure is not limited thereto. For example, the learning device 110 may send an original image before privacy protection to the image processing device 100, and receive an image generated by the image processing device 100 side to perform training. In other words, the learning device 110 may include an acquisition unit, a designation unit, a reception unit, and a learning unit.

The acquisition unit, like the image acquisition unit 201, acquires one or more images (the original images) designated by the user. The designation unit, like the protection region setting unit 203, designates a region that is desired to be protected in the image acquired by the acquisition unit as a protection region. The transmitting unit transmits, to the image processing device 100, the image acquired by the acquiring unit and information (for example, coordinates) of the protection region designated by the designation unit. The learning unit receives predetermined data required for additional training transmitted from the image processing device, such as an image, correct answer data corresponding to the image, and image description information that is information expressing the image, generates training data, and uses the training data to train a machine learning model.

In addition, in the present embodiment, additional training processing is performed as a post-stage process using the generated image, but new training can also be processed in the same manner. Furthermore, the present embodiment is applicable not only to training processing, but also to various post-stage processes that use images, such as analysis processing of false detections and non-detections.

Furthermore, the image information generation unit 204 may output text describing the input image as image description information, taking into consideration the region (protection region) set by the protection region setting unit 203. For example, text obtained by inputting each image in which each protection region illustrated in FIG. 5C has been cut out into the image information generation unit 204 may be added to the text describing the entire image. Using FIG. 5C as an example, text such as “a black-haired man wearing a hat” for the protection region 420, “four Japanese characters” for the protection region 421, and “a white Japanese license plate” for the protection region 422 may be added the text describing the entire image. Similarly, text may be generated using the correct answer data (frame position and size) designated by the correct answer assignment unit 202 as a designated region, and added to the text describing the entire image. This allows for more detailed image description information (semantic information) in the designated region.

Additionally, the obtained text may be assigned with position information for each region (for example, “a black-haired man wearing a hat in the center of the image,” “four Japanese characters in the bottom center of the image,” “a white Japanese license plate in the bottom of the image,” and the like). That is, image description information may be generated based on the position of the protection region in the designated image. This allows for more detailed image description information (semantic information) in the designated region.

Furthermore, the image processing device 100 may further include an image information correction unit that corrects image description information, which is information expressing the designated region. For this correction, the user checks the text generated by the image information generation unit 204 in S305 through a display device such as the display unit 106 and corrects it through the input unit 105. That is, when the image information correction unit receives a control command related to correcting the image description information through a user operation, the image information correction unit corrects the image description information. The image description information correction process is preferably executed immediately after the process of S305 ends, for example, but may be executed after the process of S305 ends and before the start of S308. For example, the image information generation unit 204 may function as an image information correction unit.

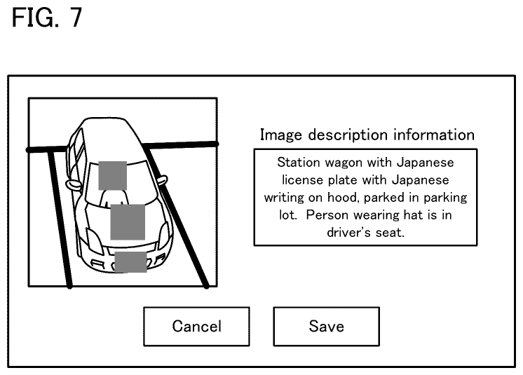

FIG. 7 is a diagram illustrating an example of a screen for correcting image description information. That is, an example of a user interface (UI) for correcting image description information is illustrated. In FIG. 7, a protection image and text as image description information are entered in an editable text box. The user can edit and save the text in the text box using the input unit 105 or the like. For example, a UI as illustrated in FIG. 7 is displayed on the display unit 106, and the user is prompted to select whether or not to correct the image description information. When correcting image description information, the text in the text box displayed on the UI is corrected using the input unit 105, and the corrected image description information is saved by pressing the “Save” button. On the other hand, by pressing the “Cancel” button displayed on the UI, the user can select not to correct the image description information. This allows users to control the information they wish to protect.

Furthermore, a detection unit may be newly provided for detecting a region including any content in an image, and the protection region setting unit 203 may use the detection result to set the protection region. For example, a face region detected by a face detector may be set as the protection region, or a license plate region detected by a license plate detector may be set as the protection region.

As described above, according to the configuration described in the first embodiment, it is possible to generate data that has little effect on processing such as learning (training images with high learning effect) while protecting information that is desired to be protected in processing such as learning.

### Second Embodiment

In the first embodiment, a training image is generated using information expressing the entire image, but in a second embodiment, a case will be described in which the fineness of the expression is adjusted for each protection region. In the following description of the second embodiment, a description of the same points as in the first embodiment will be omitted.

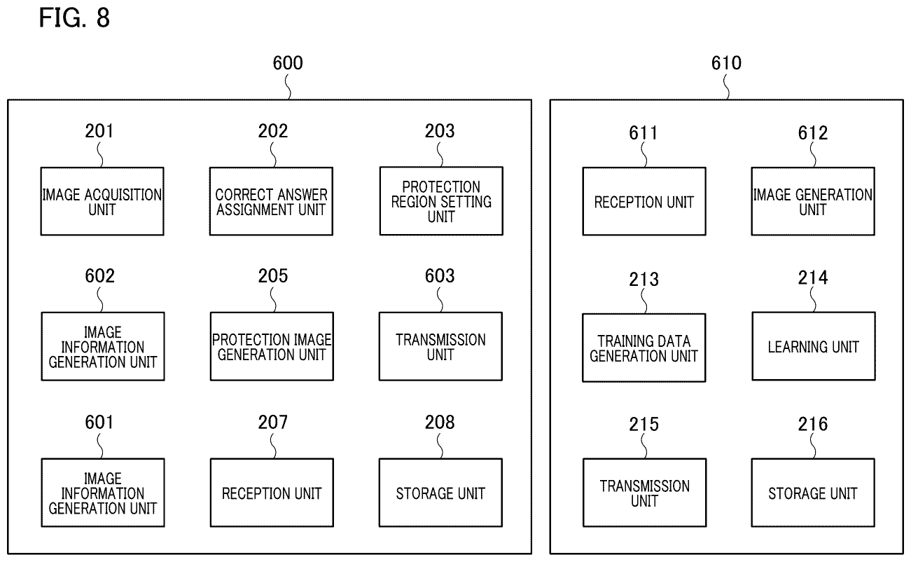

FIG. 8 is a block diagram illustrating an example of a functional configuration of an image processing device 600 and a learning device 610 in a second embodiment. The image processing device 600 includes an image acquisition unit 201, a correct answer assignment unit 202, a protection region setting unit 203, an image information adjustment unit 601, an image information generation unit 602, a protection image generation unit 205, a transmission unit 603, a reception unit 207, and a storage unit 208.

The image information adjustment unit 601 sets the fineness of information generated by the image information generation unit 602 (hereinafter, information granularity). In the present embodiment, the information granularity is set for each protection region based on the size of the protection region. Specifically, it is defined as in the following Formula (1).

$$Information granularity G = ( w \times h ) / ( wi \times hi ) \qquad ( 1 )$$

Here, w is the width of the protection region, h is the height of the protection region, wi is the width of the image, and hi is the height of the image.

The image information generation unit 602 analyzes the image in the same manner as in the first embodiment, and generates image description information (semantic information) that is information expressing a designated region. In the present embodiment, a protection region is set as a designated region, and text describing the inside of the protection region of the image for each protection region is generated as image description information, and is output based on information granularity.

Specifically, first, an image is cut out for each protection region. In the related arts, the more regions of interest there are in an image, the finer the information granularity becomes. For this reason, in the present embodiment, when the information granularity is between 0 and 0.25, a protection region is designated as a region of interest. Furthermore, when the information granularity is between 0.25 and 0.5, four regions obtained by equally dividing the protection region into four are designated as the region of interest. Furthermore, when the information granularity is between 0.5 and 1, nine regions obtained by equally dividing the protection region into nine are designated as the region of interest. Thereafter, the image information generation unit 602 generates text describing the cut-out image based on the cut-out image (that is, each protection region) and the designated region, as image description information, and outputs it.

The transmission unit 603 transmits data required for additional training to the outside. In the present embodiment, an image, correct answer data corresponding to the image, a protection region, and image description information that is information expressing the protection region are transmitted to the learning device 610.

The learning device 610 includes a reception unit 611, an image generation unit 612, a training data generation unit 213, a learning unit 214, a transmission unit 215, and a storage unit 216.

The reception unit 611 receives data required for additional training from the outside. In the present embodiment, an image, correct answer data corresponding to the image, a protection region, and image description information that is information expressing the protection region are received from the image processing device 600.

The image generation unit 612 generates training data from data required for additional training. In the Present embodiment, for an image for which image description information exists, an image for training is generated from the image, a protection region, and image description information expressing the protection region. Specifically, an image of the protection region is generated for each protection region from image description information expressing the protection region, and the image is superimposed on the image based on the position of each protection region to generate an image for training.

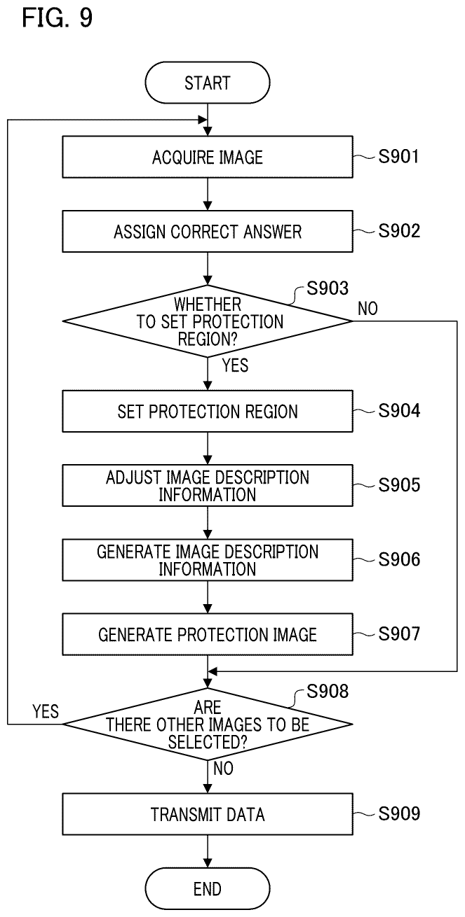

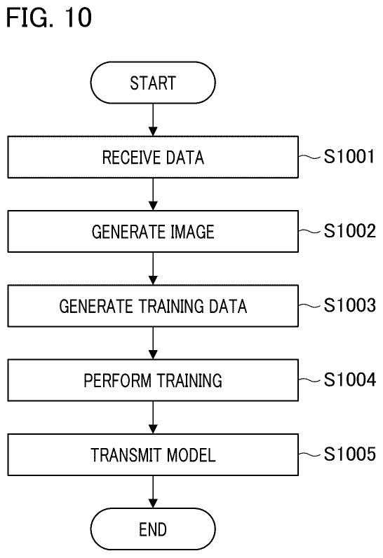

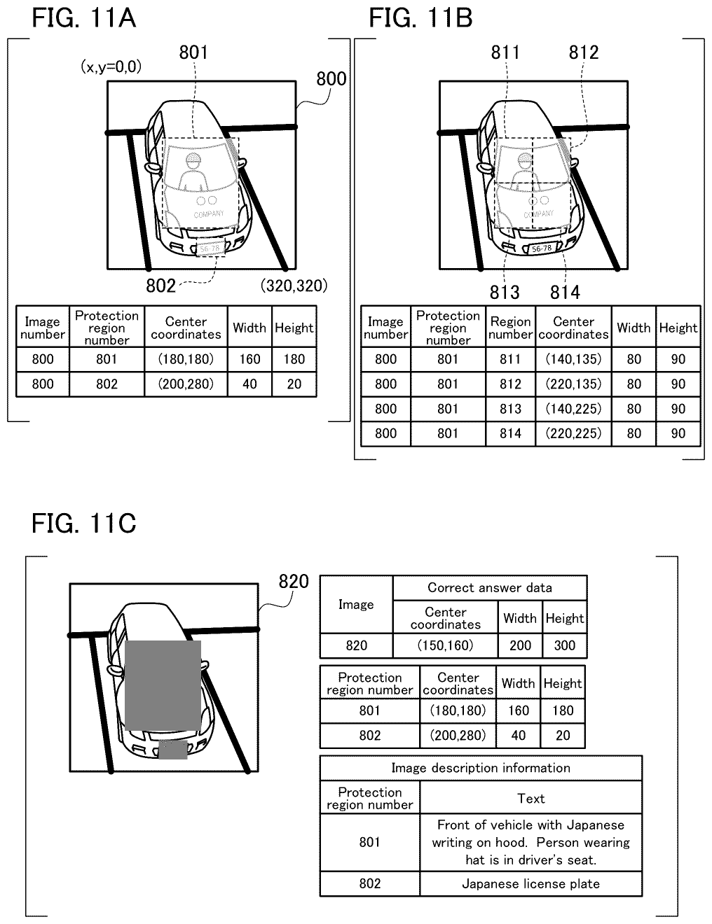

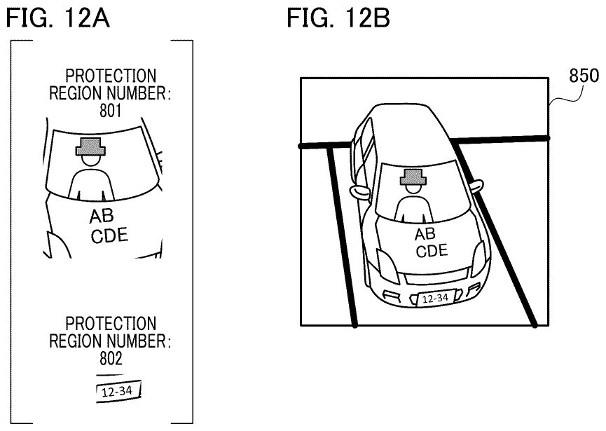

Next, the processes performed by the image processing device 600 and the learning device 610 will be described with reference to FIGS. 9 to 12B. FIGS. 9 and 10 are flowcharts illustrating additional training processing according to the second embodiment. Specifically, FIG. 9 is a flowchart of the processing on the image processing device 600 side in the additional training processing, and FIG. 10 is a flowchart of the processing on the learning device 610 side in the additional training processing. FIGS. 11A to 12B are diagrams illustrating additional training processing according to the second embodiment.

In the following, with regard to the additional training processing of the present embodiment, first, the process performed on the image processing device 600 side will be described with reference to FIG. 9. Each of the following processes illustrated in FIG. 9 is realized by the CPU 101 of the image processing device 600 executing a program stored in the memory 102. Furthermore, each process (step) is represented by adding an S to the beginning of the process (step), thereby omitting the notation of the process (step).

Note that S901 to S903 in FIG. 9 are similar to S301 to S303 in FIG. 3 of the second embodiment, and therefore a description thereof will be omitted. Furthermore, S907 and S908 are similar to S306 and S307, and therefore the description thereof will be omitted.

In S904, the user designates a protection region as a rectangle for the designated image, and the protection region setting unit 203 sets the position and size of the rectangle together with the protection region number. That is, when the user uses the input unit 105 to designate one or more rectangular regions in the designated image that he or she wishes to protect, the protection region setting unit 203 sets the designated regions as protection regions. Furthermore, the position (x, y) and size (w, h) of a rectangle in the designated image that is the protection region are detected, and a number is assigned to the protection region. For example, as illustrated in FIG. 11A, when two regions are designated by a user operation as rectangles, each of the designated regions is set as a protection region. Furthermore, the position (x, y) and size (w, h) of the rectangle of each protection region are detected, and each of protection regions 801 and 802 is numbered. Then, the protection region setting unit 203 stores the protection regions 801 and 802 in the storage unit 104 in association with the image number 800.

In S905, the image information adjustment unit 601 sets the information granularity based on the protection region set in S904. In the example of FIG. 11A, since the image size is 320×320 and the size of the protection region is 160×180, the information granularity G of the protection region 801 is as follows:

$$Information granularity G 801 = ( 160 \times 180 ) / ( 320 \times 320 ) \approx 0.2 8 .$$

Similarly, since the size of the protection region is 40×20, the information granularity G of the protection region 802 is as follows:

$$Information granularity G 802 = ( 40 \times 20 ) / ( 320 \times 320 ) \approx 0. 8 .$$

In this way, the image information adjustment unit 601 adjusts the amount of information in the image description information generated by the image information generation unit 602 based on the size information of the protection region.

In S906, the image information generation unit 602 outputs text describing the inside of the protection region of the designated image for each protection region as image description information based on the information granularity. Specifically, as illustrated in FIG. 11B, since the protection region 801 has an information granularity of 0.28, the protection region 801 is first divided equally into four. Next, an image (hereinafter, cut-out image) is created by cutting out the protection region 801 from the designated image, and text describing the cut-out image is obtained using information about the four divided protection regions 811, 812, 813, and 814. Here, it is assumed that the text obtained for the protection region 801 is “Front of a vehicle with Japanese writing on the hood. A person wearing a hat is in the driver's seat.” This process is then repeated for each protection region. Similarly, since the information granularity of the protection region 802 is 0.008, the protection region 802 is not divided, but is cut out from the designated image to create a cut-out image, and text describing the cut-out image is obtained using the information about the protection region 802. Here, it is assumed that the text “Japanese license plate” is obtained for the protection region 802. Finally, the image information generation unit 602 generates and outputs description text for all the protection regions as image description information in association with the protection region numbers.

In S909, when a protection region has been set, the transmission unit 603 transmits a protection image, correct answer data corresponding to the protection image, a protection region, and image description information to the learning device 610. When a protection region has not been set, the designated image and the correct answer data corresponding to the designated image are transmitted to the learning device 610. FIG. 11C illustrates an example of a protection image, correct answer data corresponding to the protection image, and image description information that are transmitted to the learning device 610 when a protection region has been set.

Next, with regard to the additional training processing of the present embodiment, the process performed on the learning device 610 side will be described with reference to FIG. 10. Each of the following processes illustrated in FIG. 10 is realized by the CPU 111 of the learning device 610 executing a program stored in the memory 112. Furthermore, each process (step) is represented by adding an S to the beginning of the process (step), thereby omitting the notation of the process (step). Incidentally, S1003 to S1005 are similar to S403 to S405, and therefore the description thereof will be omitted.

In S1001, when a protection region has been set, the reception unit 611 receives, from the image processing device 600, each piece of data including a protection image, correct answer data corresponding to the protection image, a protection region, and image description information corresponding to the protection image. On the other hand, when a protection region has not been set, each piece of data including a designated image and correct answer data corresponding to the designated image is received.

In S1002, when the image description information is received in S1001, the image generation unit 612 generates a training image based on the protection image, the protection region, and the image description information. Specifically, taking FIG. 12A as an example, in the case of the protection image of image number 820, an image is generated for the protection region 801 based on the text “Front of a vehicle with Japanese writing on the hood. A person wearing a hat is in the driver's seat.” In addition, for the protection region 802, an image is generated based on the text “Japanese license plate.” Then, the image generation unit 612 generates a training image as illustrated in FIG. 12B by superimposing these generated images on the protection image based on the coordinates of each protection region. Thereafter, the image number 820 of the correct answer data corresponding to the protection image is replaced with an image number 850 of the training image.

### Modification Example

The image information generation unit 602 may set the designated region as a region obtained by enlarging the protection region vertically and horizontally at a fixed magnification. This makes it possible to acquire information about the periphery of the protection region by enlarging the region of the image used to generate image description information. That is, the image information generation unit 602 can refine the image description information (semantic information) of the designated region by adjusting the amount of information about the protection region.

In addition, in addition to adjusting the amount of information in the image description information based on the size of the protection region, the image information adjustment unit 601 may also acquire the complexity within the protection region, for example the variance of pixel values within the protection region, and set the information granularity to a larger value as the variance increases. The user may directly designate the information granularity through the input unit 105. In this way, image description information (semantic information) of the designated region can be appropriately expressed.

In the second embodiment, similarly to the first embodiment, the image processing device 600 may generate the training image instead of the image generation unit 612 of the learning device 610. For example, the image information generation unit 602 or the protection image generation unit 205 of the image processing device 600 may generate the training image. Also, in the second embodiment, similarly to the first embodiment, the image processing device 600 and the learning device 610 may be integrated into one device (image processing device).

As described above, in the second embodiment, similarly to the first embodiment, it is possible to generate data that has little effect on processing such as learning (training images with high learning effect) while protecting information that is desired to be protected in processing such as learning.

### Third Embodiment

In the first embodiment, text is used as image description information, but in a third embodiment, a case will be described in which posture information of a human body is also used as image description information. In the following description of the third embodiment, a description of the same points as in the first embodiment will be omitted.

The block diagram of the present embodiment is the same as that of the first embodiment. The image processing device 100 in the present embodiment has a data generation function of generating data necessary for additional training by selecting an image that a user wishes to additionally train for a human body posture estimation device using machine learning (not illustrated), and a transmission function of transmitting data to the learning device 110. Hereinafter, in the block diagram of FIG. 2, the relevant parts for using the above-mentioned posture information of the human body will be described.

The correct answer assignment unit 202 assigns correct answer data to the image. In the present embodiment, for an image acquired by the image acquisition unit 201, the user designates, as correct answer data, the position (x, y) of a frame (rectangular frame) surrounding a human body to be detected and its size (w, h) in the image, via the input unit 105. Furthermore, the posture of the human body is analyzed from the image, and the posture information is designated as correct answer data. In the present embodiment, in order to analyze the posture of the human body, a human body posture estimation function for generating correct answer data, which is different from the human body posture estimation device, is used. In the present embodiment, the positions (x, y) of designated feature points of the human body (for example, nose, neck, left and right eyes, ears, etc.) in the image are used as posture information. The function of analyzing the posture of the human body from such an image and extracting the feature points of the human body as posture information can be realized by applying known technology, and therefore a description thereof will be omitted.

The image information generation unit 204 analyzes the designated region in the image set by the correct answer assignment unit 202, and generates semantic information (image description information) that is information expressing the designated region. Furthermore, the positions of the feature points of the human body in the correct answer data are added to the image description information.

The image generation unit 212 generates training images from data required for additional training. In the present embodiment, for an image for which image description information, which is information expressing the image and indicates the positions of feature points of the human body, exists, a training image is generated as an image for training from the image and the image description information. The function of generating an image by inputting other information such as the positions of feature points of the human body in addition to information (prompt) expressing such an image can be realized by applying known technology, and therefore a description thereof will be omitted.

The training data generation unit 213 stores the image and the correct answer data corresponding to the image as training data. The learning unit 214 trains a machine learning model using the training data. In the present embodiment, a combination of an image for training and correct answer data corresponding thereto is used as training data, and a machine learning model for estimating a human body posture is additionally trained using the training data.

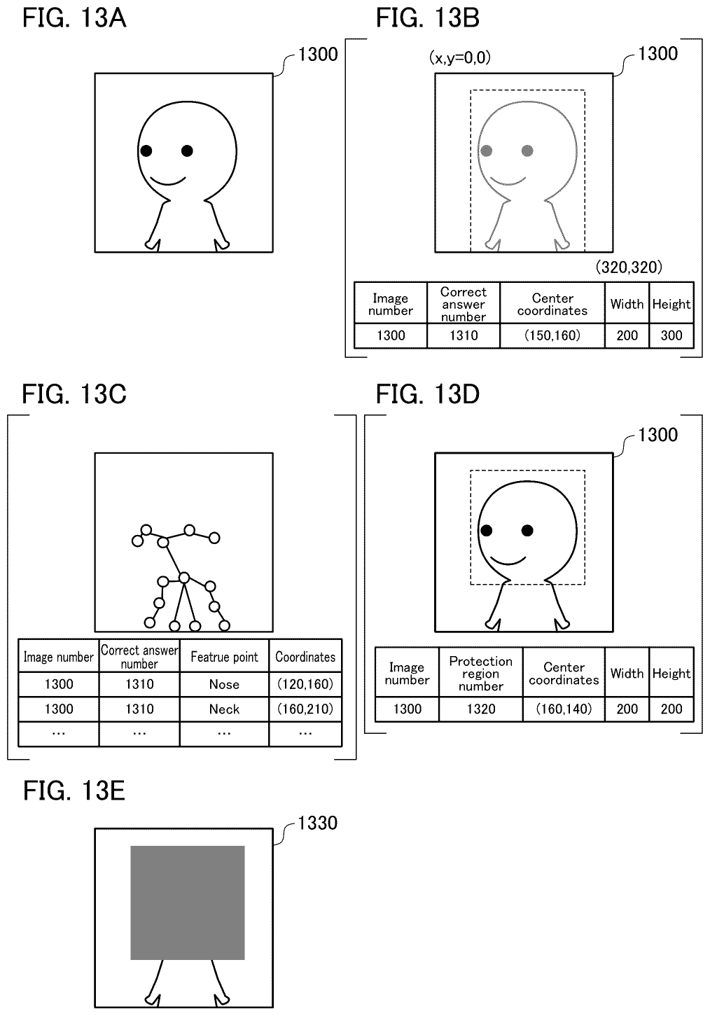

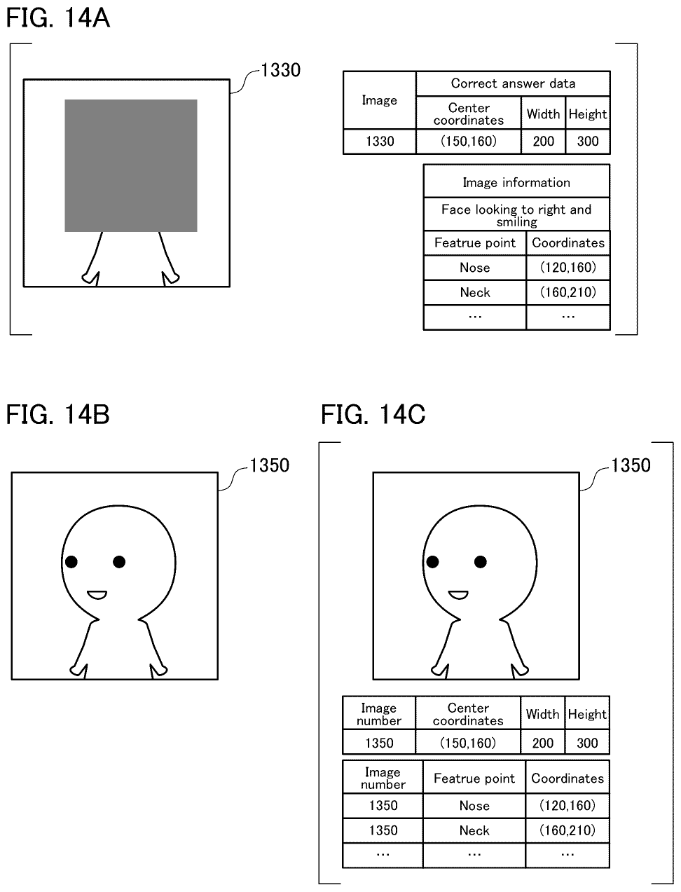

Next, the processes performed by the image processing device 100 and the learning device 110 will be described with reference to FIGS. 13A to 14C. Moreover, since the processing in the present embodiment is basically the same as that in the first embodiment, the processing will be described with reference to the flowcharts in FIGS. 3 and 4. In the following, with regard to the additional training processing of the present embodiment, first, the process performed on the image processing device 100 side will be described with reference to FIG. 3.

In S301, similarly to the first embodiment, the image acquisition unit 201 acquires one image designated by the user (hereinafter, a designated image). In the present embodiment, the image acquisition unit 201 acquires an image illustrated in FIG. 13A as an example. In the drawing, reference numeral 1300 is the image number of the acquired image.

In S302, the correct answer assignment unit 202 designates the position of a frame 1310 surrounding a human body that the user wishes to detect and estimate the posture and the size of the frame 1310 in the designated image acquired in S301 as correct answer data. Furthermore, the posture of the human body is analyzed from the image, and the position (x, y) of the designated feature point in the image is designated as the correct answer data. The correct answer data is stored in the storage unit 104 together with the image number 1300. That is, when the user uses the input unit 105 to set a frame 1310 surrounding a human body in a designated image, the correct answer assignment unit 202 designates the position and the size (width 200, height 300) of the frame 1310 surrounding the human body as correct answer data, as illustrated in FIG. 13B. Furthermore, the posture of the human body is analyzed for the region of the frame 1310 of the designated image, and feature points of the nose, neck, left and right eyes, ears, shoulders, elbows, wrists, and waist are obtained, as illustrated in FIG. 13C. The coordinates of each feature point in the image (here, the nose is (120, 160), the neck is (160, 210), etc.) are designated as correct answer data, and the coordinates of the other obtained feature points in the image are also designated as correct answer data. Then, the correct answer data is stored in the storage unit 104 in association with the image number 1300.

In S303, similarly to the first embodiment, the protection region setting unit 203 determines whether or not to set a protection region, which is a region that the user wishes to protect, in the designated image.

In S304, similarly to the first embodiment, when the user designates a protection region in the designated image as a rectangle, the protection region setting unit 203 sets the position and size of the designated rectangle. The protection region setting unit 203 then stores the designated protection region together with the image number 1300. For example, as illustrated in FIG. 14D, when a single region is designated by a user operation as a rectangle, the designated region is set as a protection region. Furthermore, the position (x, y) and size (w, h) of the rectangle of the protection region are detected, and each protection region 1320 is numbered. Then, the protection region setting unit 203 stores the protection region 1320 in the storage unit 104 in association with the image number 1300.

In S305, the image information generation unit 204 analyzes the designated region of the designated image and outputs text describing the designated image as image description information. Here, it is assumed that the text obtained is “a face looking to the right and smiling.” The image description information is stored along with the image number. Furthermore, the position information of the feature points of the human body in the correct answer data is added to the image description information.

In S306, similarly to the first embodiment, the protection image generation unit 205 performs lossy processing on the protection region of the designated image to generate a new image. FIG. 13E illustrates an example of a protection image (second image), which is an image in which the protection region is filled in gray by the protection image generation unit 205. Furthermore, the protection image generation unit 205 updates the image number 1300 of the correct answer data, the protection region, and the image description information to an image number 1330.

In S307, similarly to the first embodiment, the image acquisition unit 201 determines whether or not there are other images to be used for additional training. If it is determined that there are other images, the process proceeds to S301, and the same process as above is performed. On the other hand, if it is determined that there are no other images, the process proceeds to S308.

In S308, similarly to the first embodiment, when a protection region has been set, the transmission unit 206 transmits a protection image, correct answer data corresponding to the protection image, and image description information to the learning device 110. On the other hand, when a protection region has not been set, the designated image and the correct answer data corresponding to the designated image are transmitted to the learning device 110.

Next, with regard to the additional training processing of the present embodiment, the process performed on the learning device 110 side will be described with reference to FIG. 4.

In S401, similarly to the first embodiment, when a protection region has been set, the reception unit 211 receives, from the image processing device 100, each piece of data including a protection image, correct answer data corresponding to the protection image, and image description information. On the other hand, when a protection region has not been set, each piece of data including a designated image and correct answer data corresponding to the designated image is received. FIG. 14A illustrates an example of a protection image, correct answer data corresponding to the protection image, and image description information that are transmitted to the learning device 110 when a protection region has been set. The above is the process on the image processing device 100 side.

In S402, when the image description information is received in S401, the image generation unit 212 generates an image for training (hereinafter, a training image) based on the protection image and the image description information. FIG. 14B illustrates an example of the training image generated by the image generation unit 212. Thereafter, the image generation unit 212 replaces the image number 1330 of the correct answer data corresponding to the protection image with an image number 1350 of the training image.

In S403, the training data generation unit 213 stores the training image and the correct answer data corresponding to the training image in the storage unit 114 as training data. FIG. 14C illustrates an example in which the training image and the correct answer data corresponding to the training image are stored as training data by the training data generation unit 213.

In S404, the learning unit 214 additionally trains a machine learning model for estimating a human body posture using the training data stored in S403 (by reading the training data from the storage unit 114). In S405, the transmission unit 215 transmits the machine learning model for estimating the posture of the human body that has been trained to the image processing device 100. The above is the process on the learning device 110 side.

### Modification Example

In the present embodiment, the designated feature points of the human body that become the correct answer data in the correct answer assignment unit 202 are estimated using the human body posture estimation function for generating the correct answer data, but the present disclosure is not limited thereto. For example, the user may directly input the positions of the feature points, or the image information generation unit 204 may have a function of estimating the posture. Furthermore, as long as the posture information indicates the posture of the human body, any feature can be used, such as the mouth, eyebrows, etc., specific to the face direction, in addition to the feature points such as the neck and nose designated in the present embodiment. It is also possible to use information indicating the connections of each joint point as posture information. Furthermore, it is also possible to use the contour of the human body as posture information.

Furthermore, in the above-described Present Embodiment, the image description information includes text and posture information, but may include only posture information. In other words, if there is information feature of the posture of the human body, it is possible to generate a training image such as that illustrated in FIG. 14B.

Furthermore, in the present embodiment, posture information is used in addition to text as image description information, but three-dimensional information indicating depth data of an image, region division information of an image, or the like may also be used. The region division information is a well-known process for dividing an image into regions by grouping together similar feature values such as colors and patterns. In other words, any information indicating the contents of a protection region can be used as image description information.

As described above, in the third embodiment, similarly to the first embodiment, it is possible to generate data that has little effect on processing such as learning while protecting information that is desired to be protected in processing such as learning.

In addition, in the second and third embodiments, it is of course possible to apply a configuration in which the image processing device 100 and the learning device 110 are integrated as described in the modification example of the first embodiment, or a configuration in which the learning device 110 sends an original image before privacy protection to the image processing device 100, receives an image generated by the image processing device 100, and performs training.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the image processing device and the like through a network or various storage media. Then, a computer (or a CPU, an MPU, or the like) of the image processing device and the like may be configured to read and execute the program. In such a case, the program and the storage medium storing the program configure the present disclosure.

In addition, the present disclosure includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-063154, filed on Apr. 10, 2024, and Japanese Patent Application No. 2024-188566 filed on Oct. 25, 2024 both of which are hereby incorporated by reference herein in its entirety.

What is claimed is:

1. An image processing device comprising: at least one processor; and a memory coupled to the at least one processor, the memory storing instructions that, when executed by the at least one processor, cause the at least one processor to:
set one or more regions in a first image as a protection region;
generate image description information as information expressing at least a portion of the first image;
generate a second image based on lossy processing for the protection region in the first image; and
perform control such that a training image used for training a learning model for image analysis processing is generated based on the second image and the image description information.

2. The image processing device according to claim 1, wherein, in the control, the second image and the image description information are transmitted to a device that generates the training image based on the second image and the image description information.

3. The image processing device according to claim 1, wherein, in the control, the training image is generated based on the second image and the image description information.

4. The image processing device according to claim 1, wherein the lossy processing includes at least one of filling, mosaic processing, and blurring processing for the protection region.

5. The image processing device according to claim 1, wherein text that describes at least one of a subject in the first image or a scene in the first image is generated as the image description information.

6. The image processing device according to claim 1, wherein the image description information is generated as information expressing the protection region.

7. The image processing device according to claim 1, wherein at least one of posture information of a subject in the first image, three-dimensional information of the first image, and region division information of the first image is generated as the image description information.

8. The image processing device according to claim 1, wherein the image description information is generated based on a position of the protection region in the first image.

9. The image processing device according to claim 1, wherein the image description information is generated for each protection region.

10. The image processing device according to claim 1, wherein the at least one processor or circuit is further configured to adjust an amount of information in the image description information.

11. The image processing device according to claim 10, wherein the amount of information is adjusted based on a size of the protection region.

12. The image processing device according to claim 10, wherein the protection region is divided according to a size of the protection region, and
the image description information is generated for each divided region.

13. The image processing device according to claim 1, wherein the at least one processor or circuit is further configured to
correct the image description information.

14. The image processing device according to claim 1, wherein the at least one processor or circuit is further configured to:
detect a region in the first image that contains any content; and
set the region detected in the detection as the protection region.

15. The image processing device according to claim 1, wherein the at least one processor or circuit is further configured to
perform machine learning using the training image.

16. A learning device comprising: at least one processor; and a memory coupled to the at least one processor, the memory storing instructions that, when executed by the at least one processor, cause the at least one processor to:
set one or more regions in a first image as a protection region;
generate image description information as information expressing at least a portion of the first image;
generate a second image based on lossy processing for the protection region in the first image;
perform control such that a training image used for training a learning model for image analysis processing is generated based on the second image and the image description information;
acquire the first image;
designate the protection region in the first image;
transmit the acquired image and information about the designated protection region to the image processing device;
receive the training image generated by the image processing device; and
perform machine learning of a learning model for image analysis processing using the received training image.

17. An image processing system including an image processing device and a learning device communicatively connected to the image processing device, the image processing system comprising:
at least one processor; and a memory coupled to the at least one processor, the memory storing instructions that, when executed by the at least one processor, cause the at least one processor to:
set one or more regions in a first image as a protection region;
generate image description information as information expressing at least a portion of the first image;
generate a second image based on lossy processing for the protection region in the first image;
generate a training image used for training a learning model for image analysis processing based on the second image and the image description information; and
perform machine learning using the training image.

18. An image processing method performed by an image processing device, the image processing method comprising:
setting one or more regions in a first image as a protection region;
generating image description information as information expressing at least a portion of the first image;
generating a second image based on lossy processing for the protection region in the first image; and
performing control such that a training image used for training a learning model for image analysis processing is generated based on the second image and the image description information.

19. A non-transitory computer-readable storage medium storing a computer program including instructions for executing following processes:
setting one or more regions in a first image as a protection region;
generating image description information as information expressing at least a portion of the first image;
generating a second image based on lossy processing for the protection region in the first image; and
performing control such that a training image used for training a learning model for image analysis processing is generated based on the second image and the image description information.
